(19) United States
(12) Patent Application Publication
(10) Pub. No.: US 2006/0219625 A1
(43) Pub. Date: Oct. 5, 2006

(54) High-efficiency fuel-water filter

(76) Inventor: Robert Warner, Palm Harbor, FL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/095,659

(22) Filed: Apr. 1, 2005

(51) Int. Cl. B01D 27/00

(52) U.S. Cl. 210/443; 210/493.1; 210/497.01

(57) ABSTRACT

A high-efficiency, yet inexpensive fuel-water filter is disclosed that both optimizes filter space and water reservoir space, and includes a pleated filter media configured to substantially maximize the effective/exposed surface area of the filter media.

### FIELD OF THE INVENTION

The present invention is directed to a high-efficiency, low-cost gasoline fuel-water filter for a marine environment.

### BACKGROUND OF THE INVENTION

A marine fuel-water filter is used to remove contamination from fuel before it is sent to an engine. Generally, contamination takes to forms: particulates and water. While it may not be necessary to remove all particulates from fuel, it is certainly useful to remove particles greater than 10 microns in order to avoid clogging of an engine's injectors, which may cause the engine to burn “lean” and possibly cause damage. Water, while not as potentially damaging as particulates (at least in minute quantities), provides its own issues to the efficient operation of an engine.

Unfortunately, marine fuel-water filters, while not immensely expensive, do add to the overall costs of boat engine maintenance. However, the cost of a fuel-water filter should not necessarily be lowered if the resultant design changes substantially hinder the quality and utility of the filter. Accordingly, improvements in high-efficiency, low-cost marine fuel-water filters are desirable.

### SUMMARY OF THE INVENTION

In a first embodiment, a marine fuel-water filtering system used to eliminate contamination from gasoline includes a body having a generally cylindrical structure, the body including a side portion, a top portion and a bottom portion, wherein the top portion contains a screw-on structure and has a central fuel input port and one or more fuel output ports, a cylindrical filter unit contained within the body, wherein the filter unit includes a top cover, a bottom cover and a ten-micron or less filter media disposed between the top and bottom covers, the filter media being pleated to form a radial zig-zag pattern having peaks and nadirs, wherein the pleated filter media has more than fifty peaks, and wherein the peaks and nadirs have an expected regular distribution designed to substantially maximize the exposed surface area of the filter media.

In a second embodiment, a marine fuel-water filtering system used to eliminate contamination from gasoline includes a body having a generally cylindrical structure, the body including a side portion, a top portion and a bottom portion, wherein the top portion contains a screw-on structure and has a central fuel input port and one or more fuel output ports, and wherein the side portion and bottom portion of the body are of unitary construction, and a cylindrical filter unit contained within the body, wherein the filter unit includes a top cover, a bottom cover and a ten-micron or less filter media disposed between the top and bottom covers, the filter media being pleated to form a radial zig-zag pattern having peaks and nadirs, wherein the cylindrical filter unit occupies a filter-zone located over a water reservoir-zone, the water reservoir-zone used to collect water contamination, wherein the water reservoir-zone occupies less that a linear inch along the central axis of the filter body

In a third aspect, a marine fuel-water filtering system used to eliminate contamination from gasoline includes a body having a generally cylindrical structure, the body including a side portion, a top portion and a bottom portion, wherein the top portion contains a screw-on structure and has a central fuel input port and one or more fuel output ports, and wherein the side portion and bottom portion of the body are of unitary construction, a cylindrical filter unit contained within the body, wherein the filter unit includes a top cover, a bottom cover and a ten-micron or less filter media disposed between the top and bottom covers, the filter media being pleated to form a radial zig-zag pattern having peaks and nadirs, wherein the cylindrical filter unit occupies a filter-zone located over a water reservoir-zone, the water reservoir-zone used to collect water; and wherein the ratio of filter-zone to water reservoir-zone is at least 4:1 as measured linearly along the central axis of the filter body.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts a conventional fuel-water filter.

FIG. 2 depicts details of the filter element of the conventional fuel-water filter of FIG. 1.

FIG. 3 depicts a second conventional fuel-water filter.

FIG. 4A is a side-view of a high-efficiency fuel-water filter.

FIG. 4B depicts the top-view of the high-efficiency fuel-water filter of FIG. 4A.

FIG. 5 provides details of the filter element of the high-efficiency filter of FIG. 4A.

FIG. 6 provides further details of the filter element of the high-efficiency filter of FIG. 4A.

FIGS. 7 and 8 provide comparable filter element details for conventional filter elements as compared to the filter element of FIG. 5.

### DETAILED DESCRIPTION

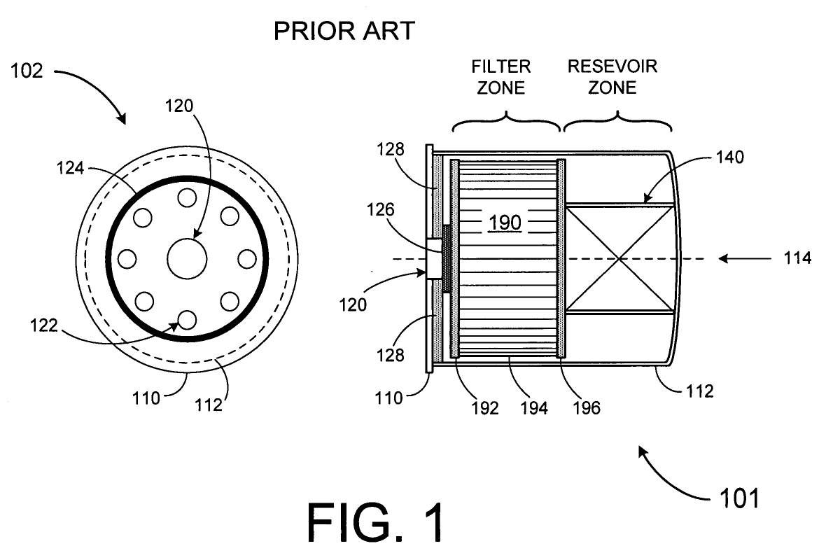

FIG. 1 depicts a top and side view of a first convention screw-up fuel-water filter 101. As shown on FIG. 1, the first conventional filter 101 includes a generally cylindrical body casing 112 covered by a top 102. The top 102 includes a top cover 110 having a plate 128 attached underneath and a first seal 124 fixed on top. In the middle of the plate 128 is a threaded input port 120 (which give rise to the acronym “screw top” filter), and surrounding the input port 120 are a number of output ports 122.

Encased within the body casing 112 is a filter element 190 with a second seal 126 on one side and a spring 140 on the other. The spring 140 serves both to define a reservoir-zone from a filter-zone as well as apply pressure of the filter 190 to the second seal 126 to assure a proper sealing between the filter element 194 and the plate 128.

As further shown in FIG. 1, the filter 190 includes a top cover 192, a bottom cover 196 and a filter media 194 disposed between the covers 192 and 196 and sealed to the covers 192 and 196 via an epoxy or similar substance (not shown).

A review of FIG. 1 shows that the filter-zone and reservoir-zone of the first filter arc of approximate equal size as measured linearly along the cylindrical central axis 114 of the filter 101. Measurements confirm that the reservoir-zone is about 2 inches long for both a sixty-gallon/hr filter and a ninety gallon/hr filter, while the filter-zone is about 1.5 inches for sixty-gallon/hr filter and about three inches for a ninety gallon/hr filter.

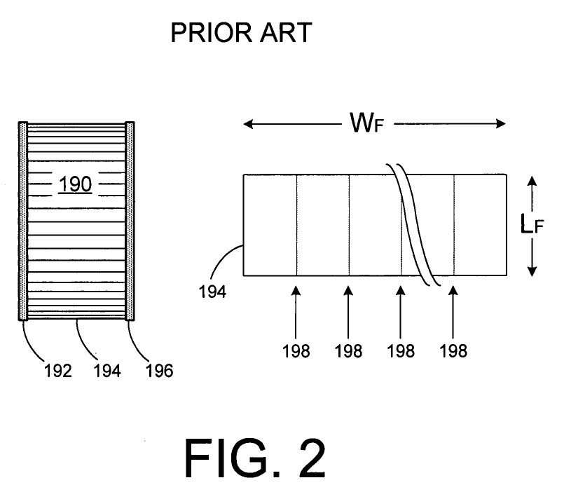

FIG. 2 shows the filter element 190 of FIG. 1 on the left with the filter media 194 depicted to the right—laid out flat to better display the square area of the media 194 as well as provide a view of the media's pleats 198. The filter media 194 has a length LF of approximately 1.5 or 3 inches (depending on the fuel-flow rating) and a width WF of about 11 feet. The distance between the pleats 198 is approximately one inch. Total square area of the media is about 200 or about 400 square-inches again depending on the fuel-flow rating.

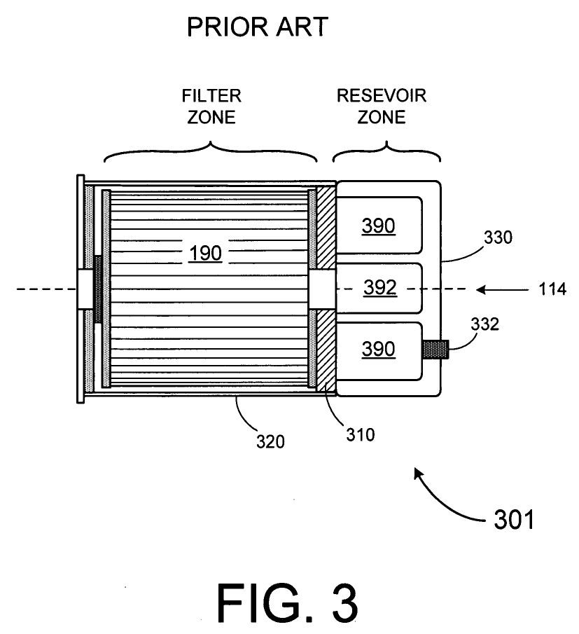

FIG. 3 depicts a simplified diagram of a second “premium” fuel-water filter 301 similar to the filter of FIG. 1, but having a two-piece lower body casing with casing elements 320 and 330 coupled together with coupling element 310. Body element 330 has an outer chamber 390 and inner chamber 392 that are used to collect water and, when element 330 is made of a transparent material, provide a view for the fuel and removed water contamination. Valve 332 is provided to “bleed” water contamination from chamber 390. It should be appreciated that for this “premium” filter 301, the filter element 190 is about 2.75 inches long for a 60 gallon/hr filter and 4.25 inches long for a 90 gallon/hr filter. The filter media 194 is about 11 feet wide with one-inch pleat spacing, and has a square area of 360 square-inches for a 60 gallon/hr filter and 560 square-inches long for a 90 gallon/hr filter.

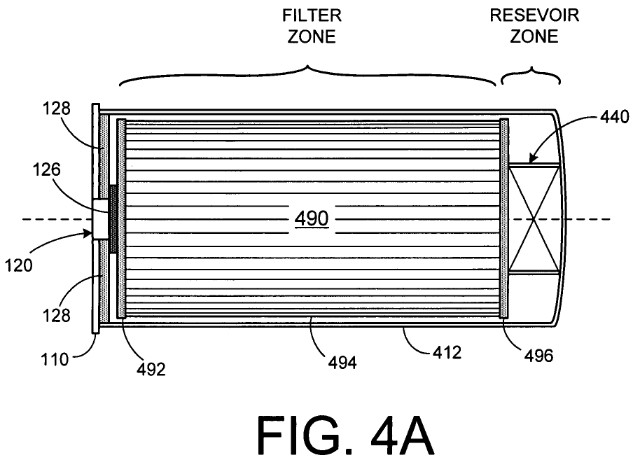

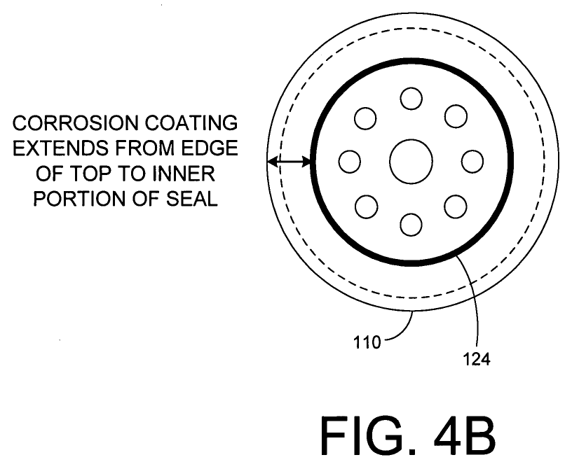

FIG. 4A depicts a high-efficiency fuel-water filter 401 according to the present disclosure. As shown in FIG. 4A, the filter 401 appears similar in structure to that of FIG. 1 but with some apparent differences.

The first difference of note is the ratio of filter-zone to reservoir-zone, which for the present example is about 5:1 with filter element 490 being about five inches long and the reservoir-zone being constrained to about an inch along the central axis 414. The inventor of the present apparatus has discovered that, for a typical, suggested maintenance cycle of 50 hours, the volume of the reservoir-zone is more than adequate to handle any reasonable amount of water contamination. Any more water contamination is a sign of a much more severe problem with a fuel supply that a consumer should be aware or made aware. Accordingly, it should be appreciated that the filter zones of conventional filters may represent wasted space and/or perhaps mask other problems of which a consumer should be made aware.

Also shown in FIG. 4A, the filter-zone is occupied by spring 440, and the filter element 490 has a top cover 492, a bottom cover 496 and a filter media 494 disposed between. The filter media has a length of about five inches and a width of about seven feet for a total square area of 420 square-inches.

While the filter media of the instant filter element 490 appears similar to that of the filter elements of FIGS. 1-3, there are more differences that will be made apparent below.

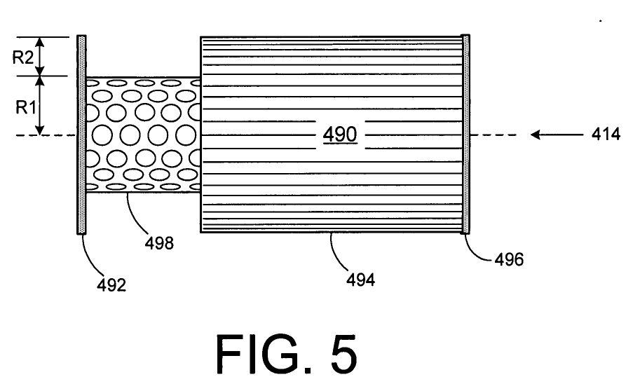

For example, FIG. 5, depicts the filter element 490 of FIG. 4 in greater detail. As shown in FIG. 5, the filter element 490 has a portion of filter media 494 removed to expose an inner perforated core 498. For the present embodiment, the filter media 494 (which is pleated in about a radial line with respect to axis 414) has an inner radial distance R1 of about one inch and a radial thickness, i.e., pleat height, R2 of about 9/16ths of an inch. The filter media 494 has a pleat density of 8 pleats per inch and a total of about 70-71 outer (peak) pleats and another 70-71 inner (nadir) pleats.

While the particular dimensions and characteristics of filter element 490 have been found useful for a particular embodiment of a 90 gallon/hr gasoline marine filter, it should be appreciated that each dimension and characteristic can vary from embodiment to embodiment as desired or otherwise found advantageous. Further, it should be appreciated that the particular dimensions, filter media material and other factors may change when other fuels, such as diesel, are used.

Returning to FIG. 4A, while not specifically shown, the outer surface of container 412 is coated with an anti-corrosion coating, suitable for highly-corrosive, salt-water marine environments. For the particular embodiment of FIG. 4B, the anti-corrosion coating is a polyurethane-based paint having at least a minimal thickness useful for providing a moisture resistant, anti-corrosive shielding. An optional undercoating, such as a paint primer, can also be applied. However, in various embodiments, the anti-corrosion coating can be a paint (especially a marine-grade paint), an enamel (considered a type of paint for the purposes of this disclosure), an epoxy or lacquer-based coating, a metal coating, such as a chrome or anodized zinc coating, or any other known or later developed coating useful for corrosion resistance.

Continuing to FIG. 4B, which depicts the top of the high-efficiency fuel-water filter 401 of FIG. 4A, it should be appreciated that the anti-corrosive coating discussed immediately above can extend all the way from the outer-edge of top 100 to the seal 124, and in some embodiments to the inner edge of the seal 124. This extension of corrosion coating is significant in that the corrosion resistance provided by such a robust coating enables the inventor to provide an inexpensive screw-top filter having a minimal amount of corrosion throughout the use of the filter 401.

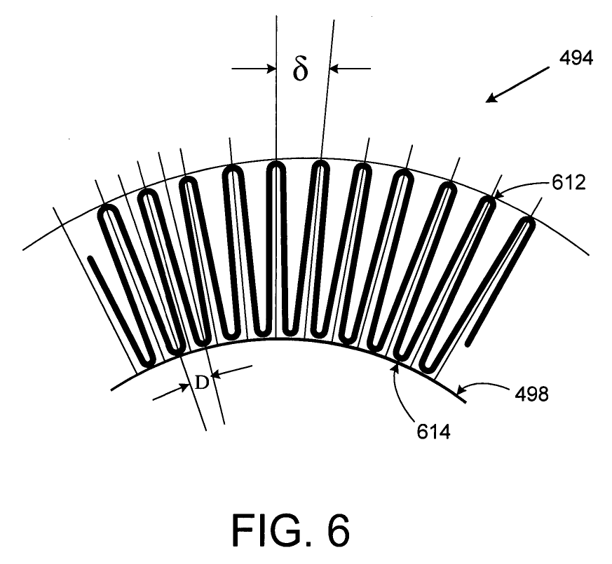

FIG. 6 depicts the pleat-pattern of filter media 494 in greater detail. As shown in FIG. 6, the filter media 494 is pleated in a radial pattern over core 498 and has a number of peaks (high-points) 612 and nadirs (low-points) 614. Generally, both peaks 612 and nadirs 614 have a regular angular spacing δ from one another, and nadirs 614 have a regular linear spacing D from one another (with slight variances possible due to imperfect manufacturing). The regular spacing of the peaks and nadirs enables the filter media 494 to take on “V” shaped valleys between peaks and inverted valleys between nadirs to substantially maximize the exposure of the media 494 to passing fluid. That is, the present shape avoids waste of filter media that may occur due to instances where the valleys between peaks and nadirs become too narrow or narrow to the point where the valley walls touch.

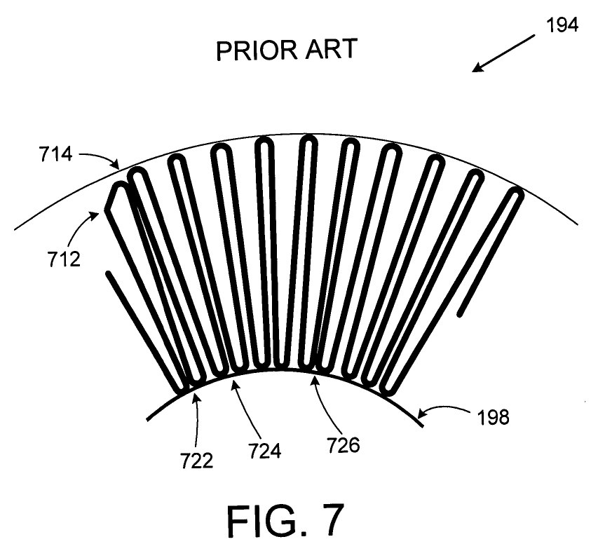

While the configuration of FIG. 6 might appear to be an obvious configuration, the reality for conventional screw-top fuel-water filters depicts a substantially different picture. For example, FIG. 7 depicts a pleating arrangement for a conventional fuel-water filter media 194. As shown in FIG. 7, media 194 does not have the regularly-spaced peaks and nadirs or the efficient “V” shaped valleys and invented valleys.

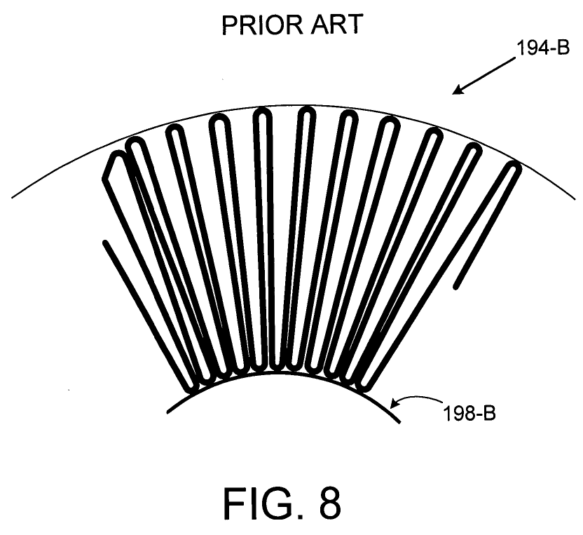

To the contrary, conventional filter elements typically have peak touching points 714, non-pleated (defect) bends 712, touching nadirs 722 and 726 and constriction zones 724 formed when nadirs (or peaks) come substantially close, but don't quite touch. Generally, these problems can be caused when the pleat-height is excessive in view of the inner radius of core 198, the thickness of the filter media and the number of pleats. FIG. 8 depicts the same syndrome for a filter media 194-B having an even greater height with a respectively small radius core 198-B.

As of the ratio of pleat density or pleat height to inner radius becomes too great, whole sections of a filter media become ineffective as little or no fluid can easily pass constriction zones or point where nadirs touch, leaving regions about the nadirs as the only effective filtering area. The consequential effect on filter efficiency can be substantial.

For example, the invention of the present filter of this disclosure has developed filter media having a pleat height of 9/16ths of an inch and total width W_{F} of about 7 feet, whereas conventional filters have a pleat height of about one inch and a total width W_{F} of about 11 feet. However, despite the greater amount of filter media used per linear inch of length L_{F}, the approach of the inventor's filter element will nonetheless provide for a more effective/exposed filter media area while using less filter media material.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A marine fuel-water filtering system used to eliminate contamination from gasoline, comprising:
a body having a generally cylindrical structure, the body including a side portion, a top portion and a bottom portion, wherein the top portion contains a screw-on structure and has a central fuel input port and one or more fuel output ports; and
a cylindrical filter unit contained within the body, wherein the filter unit includes a top cover, a bottom cover and a ten-micron or less filter media disposed between the top and bottom covers, the filter media being pleated to form a radial zig-zag pattern having peaks and nadirs;
wherein the pleated filter media has more than fifty peaks, and wherein the peaks and nadirs have an expected regular distribution designed to substantially maximize the effective surface area of the filter media.

2. The marine fuel-water filtering system of claim 1, wherein the side portion and bottom portion of the body are of unitary construction.

3. The marine fuel-water filtering system of claim 1, wherein the pleated filter media has more than fifty peaks, and wherein the peaks and nadirs have an expected regular distribution designed to substantially maximize the effective surface area of the filter media.

4. The marine fuel-water filtering system of claim 3, wherein the pleated filter media has more than sixty peaks, and wherein the peaks and nadirs have an expected distribution regular designed to substantially maximize the effective surface area of the filter media.

5. The marine fuel-water filtering system of claim 3, wherein the pleated filter media has more than sixty-five peaks, and wherein the peaks and nadirs have an expected distribution regular designed to substantially maximize the effective surface area of the filter media.

6. A marine fuel-water filtering system used to eliminate contamination from gasoline, comprising:
a body having a generally cylindrical structure, the body including a side portion, a top portion and a bottom portion, wherein the top portion contains a screw-on structure and has a central fuel input port and one or more fuel output ports, and wherein the side portion and bottom portion of the body are of unitary construction; and
a cylindrical filter unit contained within the body, wherein the filter unit includes a top cover, a bottom cover and a ten-micron or less filter media disposed between the top and bottom covers, the filter media being pleated to form a radial zig-zag pattern having peaks and nadirs;
wherein the cylindrical filter unit occupies a filter-zone located over a water reservoir-zone, the water reservoir-zone used to collect water contamination, wherein the water reservoir-zone occupies less that a linear inch along the central axis of the filter body

7. The marine fuel-water filtering system of claim 6, wherein the pleated filter media has more than sixty peaks, and wherein the peaks and nadirs have an expected distribution regular designed to substantially maximize the effective surface area of the filter media.

8. The marine fuel-water filtering system of claim 7, wherein the pleated filter media has more than sixty-five peaks, and wherein the peaks and nadirs have an expected distribution regular designed to substantially maximize the effective surface area of the filter media.

9. The marine fuel-water filtering system of claim 7, wherein the filter-zone occupies more than four linear inches along the central axis of the filter body.

10. The marine fuel-water filtering system of claim 9, wherein the filter-zone occupies at least five linear inches along the central axis of the filter body.

11. A marine fuel-water filtering system used to eliminate contamination from gasoline, comprising:
a body having a generally cylindrical structure, the body including a side portion, a top portion and a bottom portion, wherein the top portion contains a screw-on structure and has a central fuel input port and one or more fuel output ports, and wherein the side portion and bottom portion of the body are of unitary construction; and
a cylindrical filter unit contained within the body, wherein the filter unit includes a top cover, a bottom cover and a ten-micron or less filter media disposed between the top and bottom covers, the filter media being pleated to form a radial zig-zag pattern having peaks and nadirs;
wherein the cylindrical filter unit occupies a filter-zone located over a water reservoir-zone, the water reservoir-zone used to collect water; and wherein the ratio of filter-zone to water reservoir-zone is at least 4:1 as measured linearly along the central axis of the filter body

12. The marine fuel-water filtering system of claim 11, wherein the pleated filter media has more than fifty peaks, and wherein the peaks and nadirs have an expected regular distribution designed to substantially maximize the effective surface area of the filter media.

13. The marine fuel-water filtering system of claim 12, wherein the pleated filter media has more than sixty peaks, and wherein the peaks and nadirs have an expected distribution regular designed to substantially maximize the effective surface area of the filter media.

14. The marine fuel-water filtering system of claim 12, wherein the pleated filter media has more than sixty-five peaks, and wherein the peaks and nadirs have an expected distribution regular designed to substantially maximize the effective surface area of the filter media.

15. The marine fuel-water filtering system of claim 7, wherein the filter-zone occupies more than four linear inches along the central axis of the filter body.

16. The marine fuel-water filtering system of claim 9, wherein the filter-zone occupies at least five linear inches along the central axis of the filter body.

17. A marine fuel-water filtering system used to eliminate contamination from gasoline, comprising:
a body having a generally cylindrical structure, the body including a side portion, a top portion and a bottom portion, wherein the top portion contains a screw-on structure and has a central fuel input port and one or more fuel output ports, and wherein the side portion and bottom portion of the body are of unitary construction; and
a filter unit contained within the body, wherein the filter unit includes a top cover, a bottom cover and a ten-micron or less filter media disposed between the top and bottom covers, the filter media being pleated to form a radial zig-zag pattern having peaks and nadirs and being formed into a generally cylindrical shape having an outer radius and an inner radius;
wherein the inner radius of the pleated filter media is large enough to prevent substantially all of the nadirs from touching or forming constriction zones.

18. The marine fuel-water filtering system of claim 17, wherein the distance between the inner radius and outer radius is less than 14/16ths of an inch.

19. The marine fuel-water filtering system of claim 18, wherein the distance between the inner radius and outer radius is less than 12/16ths of an inch.

20. The marine fuel-water filtering system of claim 18, wherein the distance between the inner radius and outer radius is about or less than 10/16ths of an inch.

21. The marine fuel-water filtering system of claim 17, wherein the distance between the inner radius and outer radius is greater than 8/16ths of an inch.

22. The marine fuel-water filtering system of claim 17, wherein the pleated filter media has between about fifty-five to about eighty-five peaks, and wherein the peaks and nadirs have an expected regular distribution designed to substantially maximize the effective surface area of the filter media.

23. The marine fuel-water filtering system of claim 22, wherein the pleated filter media has between about sixty to about eighty peaks.

24. The marine fuel-water filtering system of claim 17, wherein the inner radius is greater than 13/16ths of an inch.

25. The marine fuel-water filtering system of claim 17, wherein the inner radius is about one inch or more.

26. The marine fuel-water filtering system of claim 17, wherein inverted “V” valleys between substantially all of the nadirs are formed.

27. A marine fuel-water filtering system containing a filter unit within, the marine fuel-water filtering system being used to eliminate contamination from gasoline, comprising:
a body having a generally cylindrical structure, the body including a side portion, a bottom portion and a top portion, wherein the top portion contains a screw-on structure and has a central fuel input port and one or more fuel output ports, and wherein the top-portion contains a seal located between the edge of the top portion and the input and output ports; and
wherein the region between the edge of the top-portion and the seal is all or substantially all coated with an anti-corrosion coating.

28. The marine fuel-water filtering system of claim 27, wherein the anti-corrosion coating extends to the inner-edge of the seal.

29. The marine fuel-water filtering system of claim 27, wherein the anti-corrosion coating is one of a paint, an epoxy and a metal coating.

30. The marine fuel-water filtering system of claim 27, wherein the anti-corrosion coating is a marine-environment grade paint.

31. The marine fuel-water filtering system of claim 30, wherein the anti-corrosion coating is substantially similar to a paint coating covering the side-portion of the fuel-water filter.
